(19) United States
(12) Patent Application Publication
(10) Pub. No.: US 2009/0138409 A1
(43) Pub. Date: May 28, 2009

(54) Access for Non-Accredited Investor to Simulated Hedged and Leveraged Investments through Exempt Variable Rate Term Deposit Vehicles

(76) Inventor: Jason Galanis, Beverly Hills, CA (US)

Correspondence Address: MERCHANT & GOULD PC, P.O. BOX 2903, MINNEAPOLIS, MN, 55402-0903, US

(21) Appl. No.: 12/114,521

(22) Filed: May 2, 2008

Related U.S. Application Data
(60) Provisional application No. 60/916,223, filed on May 4, 2007.
(60) Provisional application No. 61/021,378, filed on Jan. 16, 2008.

(51) Int. Cl. G06Q 40/00

(52) U.S. Cl. 705/36 R

(57) ABSTRACT

An online investment system includes an entry module programmed to receive information about an investor, retrieve the investor's credit score, and value one or more assets pledged by the investor to fund the investor's investment. The system also includes an investment options module programmed to offer the investor a plurality of investment options based on the investor's credit score, at least one of the investment options including a term deposit tied to performance of a hedge fund index.

### RELATED APPLICATIONS

This application claims the benefit of U.S. Patent Application Ser. No. 60/916,223 filed on May 4, 2007 and U.S. Patent Application Ser. No. 61/021,378 filed on Jan. 16, 2008, the entireties of which are hereby incorporated by reference.

### BACKGROUND

Mutual funds are long by law. This exposes millions of investors to market risks in the event that markets only go up. There has been a long-term bull market over the past 25 years. In that period, new investors in America have begun investing in the stock market. Some of this new investment class invests through mutual funds. Accordingly, mutual fund assets have grown to over $17 trillion as of 31 Dec. 2006. As a result, $17 trillion of investor money is exposed to market downturns, which have occurred over time in market economies.

Hedge funds were created in 1959 as a pooled investment vehicle that was specifically designed to ‘hedge’ investment risk. Methods for managing risk are widely varied but include the ability to sell short securities. Selling short is the process of borrowing stock at a high price while simultaneously selling it to a willing buyer with the intent of buying the security back at a lower price at a later date. Despite the widespread use of short selling and other hedging strategies, mutual funds may not use such tools. Investors are at a competitive disadvantage as a result and at more risk.

Furthermore, the US Securities and Exchange Commission has deemed hedge funds inappropriate for the average investor. US securities laws restrict investors in hedge funds to “accredited investors.” Accredited investors are defined as any natural person who had individual income in excess of $200,000 in each of the two most recent years or joint income with that person's spouse in excess of $300,000 in each of those years and has a reasonable expectation of reaching the same income level in the current year. This definition includes approximately 8% of US households. Therefore, 92% of households in the US are precluded by law from participating in hedge fund investments. They are therefore exposed to more market risk than investors who are “qualified.” Further, as hedge funds get larger, their minimum investments get larger and larger. Many already start at $1 million or more for an initial investment.

Hedge funds have become more prevalent in today's financial markets. Hedge funds, as defined, represent approximately $1.4 trillion of assets worldwide and about $850 billion from American investors. Hedge funds assets have grown by 3,000% from 1990 to 2006, making it one of the largest growing assets classes in the world financial markets. However, Americans have approximately 95% less assets in hedge funds than in mutual funds. Furthermore, there is an increasing gap between the privileged class of investors and the average investor.

### SUMMARY

According to one aspect, an online investment system includes an entry module programmed to receive information about an investor, retrieve the investor's credit score, and value one or more assets pledged by the investor to fund the investor's investment. The system also includes an investment options module programmed to offer the investor a plurality of investment options based on the investor's credit score, at least one of the investment options including a term deposit tied to performance of a hedge fund index.

According to another aspect, a method for investing in an online hedge fund index includes: receiving information about the investor; performing a credit check on the investor; offering a plurality of investment options to the investor based in part on results of the credit check, at least one of the investment options including a term deposit tied to performance of a hedge fund index; receiving assets to fund the investor's choice of investment; estimating a value of the assets; and receiving an executed agreement from the investor for the investor's selected investment option.

According to yet another aspect, a method for a financial institution to offer a non-accredited investor access to a hedge fund index includes: receiving information about the investor; performing a credit check on the investor; offering a certificate of deposit based in part on results of the credit check, performance of the certificate of deposit being tied to performance of a hedge fund index; presenting the investor with a plurality of investment choices for the investor to fund the investor's investment, the investment choices including one or more of: a secured real estate loan; a secured securities portfolio loan; an unsecured signature loan; an investment secured by a certificate of deposit loan; loans on insurance policies; college fund savings accounts; health savings accounts; retirement accounts; and future value gift cards or accounts; valuating assets provided by the investor based on the investment choices; receiving an executed agreement from the investor for the certificate of deposit; investing the assets from the investor in the hedge fund index; and paying proceeds of the certificate of deposit at maturity, at least a portion of the proceedings being tied to the performance of the hedge fund index.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system for investing in a hedge fund index.

FIG. 2 shows additional details of the system of FIG. 1.

FIG. 3 shows another example system for investing in a hedge fund index.

FIGS. 4 and 5 show an example method for investing in a hedge fund index.

FIG. 6 shows an example method for managing an investment in a hedge fund index.

### DETAILED DESCRIPTION

This disclosure includes descriptions of non-limiting embodiments. For example, the description of the simulated hedge fund investment system relates only to a description of some embodiments. Other embodiments of the simulated hedge fund investment system may or may not include the features disclosed herein. Moreover, disclosed advantages and benefits may apply to only some embodiments, and should not be used to limit the disclosure.

In example embodiments described herein, a simulated hedge fund investment system links the return provided by a banking investment instrument, such as a certificate of deposit, to a hedge fund index. In some embodiments, the individual client investor is guaranteed the return of the initial investment principal. In yet other embodiments, the simulated hedge fund investment system uses a unique approach to calculate the returns for the investors.

As an example, assume that an individual invests $1,000 in a certificate of deposit issued by a bank. In one embodiment, the rate of return of the certificate of deposit is linked to a hedge fund index. In this example, the bank transfers the $1,000 to a management entity. The management entity, using its financial leverage, can then invest additional money, along with the individual investor's $1,000, in the hedge fund index. At the end of the specified investment period, the investment returns are calculated using the hedge fund index Net Asset Value (NAV), and the returns are shared between the management entity and the individual investor.

In example embodiments, the systems and methods described herein facilitate access to the benefits associated with hedge fund investment by: (i) eliminating accredited investor restrictions; and (ii) eliminating hedge fund minimums defined by the criteria for a single investor. As such, the systems and methods described herein open the benefits of hedge fund investment to many investors. Further, online brokerages further open access to millions of investors.

Hedge funds can be volatile investment vehicles and are subject to loss. Some embodiments described herein seek to ‘hedge’ this risk of impairment to principal by linking the hedge fund performance to a term deposit. For example, aspects of some embodiments can include principal protection. An embodiment of the disclosure seeks to preserve principal by being a term deposit issued by a regulated bank. The term deposit has up-side participation, but will not be less than principal at maturity.

In example embodiments, the investment instrument sold to the investor, such as a certificate of deposit, is not a security. As such, any financial intermediary can sell, distribute, or buy a financial instrument that simulates the return of a security. However, the instrument itself is not a security.

US commercial banks hold American household investments, some of which are held in term deposits. This capital is generally ‘lent’ to banks at a defined interest rate or at a variable interest rate. In example embodiments, banks can use the systems and methods described herein to attract assets by making their CD products more attractive.

Example embodiments described herein can stimulate the flow of new investment capital into hedge funds. Also, the base of investment capital is broadened. Also, the investment capital has a longer term horizon given it is a defined term. Therefore, the example embodiments described herein make the index investable not only for the retail investor, but also as a hedging tool for the issuing bank.

Example embodiments described herein also address the statistically proven investment strategy of diversification. The preferred embodiments described herein link the term deposit variable rate to a third party composite of hedge funds. The composite represents multiple hedge funds, thereby diversifying risk instead of concentrating investment in a single fund or a few hedge funds.

In another embodiment, the investments in the hedge fund index can be ‘leveraged’ through a simulated margin. Other configurations and examples are possible.

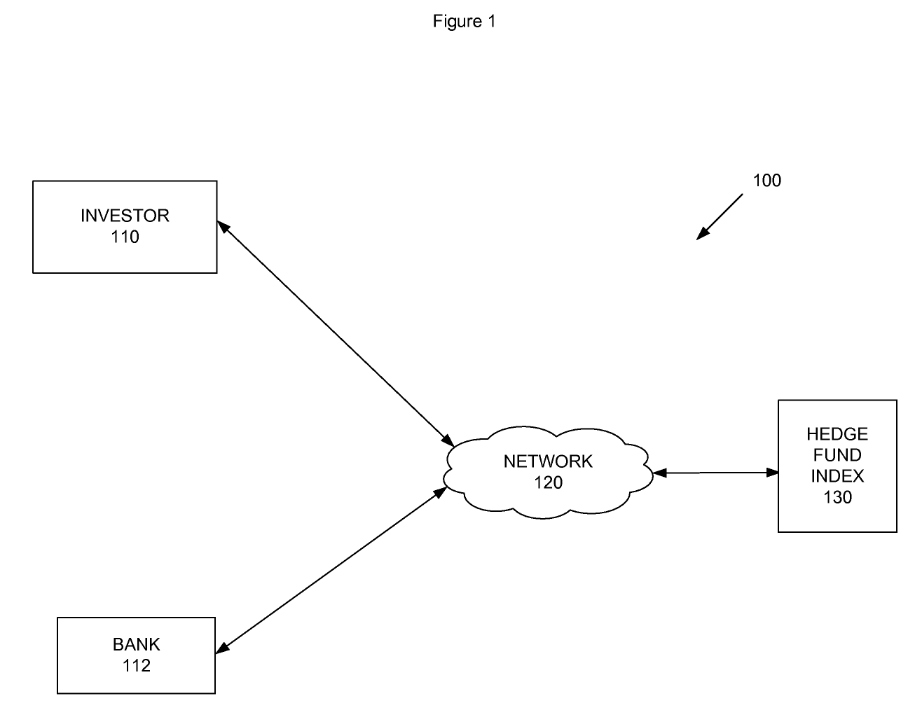

Referring now to FIG. 1, in example embodiments described herein, investment in the hedge fund index is accomplished using an online system 100. In the example shown, the system 100 includes an investor 110, a financial institution such as a bank 112, and a hedge fund index 130.

In the example shown, the investor 110, the bank 112, and the hedge fund index 130 communicate with one another over a network 120. For example, as described further below, the investor 110, the bank 112, and the hedge fund index 130 can use one or more computer systems to interface with the network 120 and communicate therebetween.

In example embodiments, the investor 110 communicates with the bank 112 to access an online application for a term deposit. Personally identifiable information for the investor 110 is inputted and transmitted electronically to the bank 112. The bank 112 performs an identification verification of the investor 112 via third party databases.

The investor 110 agrees with the terms of service and selects two variable entries identified as the term deposit amount and the duration. A Participation Rate Table is contained in a database and identifies the offered Participation Rate at the current date, a figure that may vary from time to time based on market conditions and other factors.

The hedge fund index 130 of the system 100 sets a start date for the investment, which is a fixed day of the month each month. Once monthly data is received from a third party provider of information, which is being published, the monthly increase of the composite NAV is multiplied times the dollar amount of the Original Deposit Amount and the Original Deposit Amount is then multiplied times the Participation Rate in order to derive a monetary amount. The resulting figure is transferred to the bank general ledger account where the individual deposit accounts are credited with the monetary value. The general ledger account is accessible through encrypted password protected software over a wide area network, such as the Internet.

In example embodiments, the hedge fund index 130 is published such that the bank 112 can invest therein. In this manner, the bank 112 may hedge its risk. Therefore, investment by the bank 112 is an interactive two-way process. The bank 112 not only receives information, but acts on the information by making investments. If the bank 112 does not have information related to the underlying weighting in the composite associated with the hedge fund index 130, the ability to hedge is minimized. Therefore, in example embodiments, the weighting can be published so that the bank 112 has information associated with the underlying investment in the hedge fund index 130.

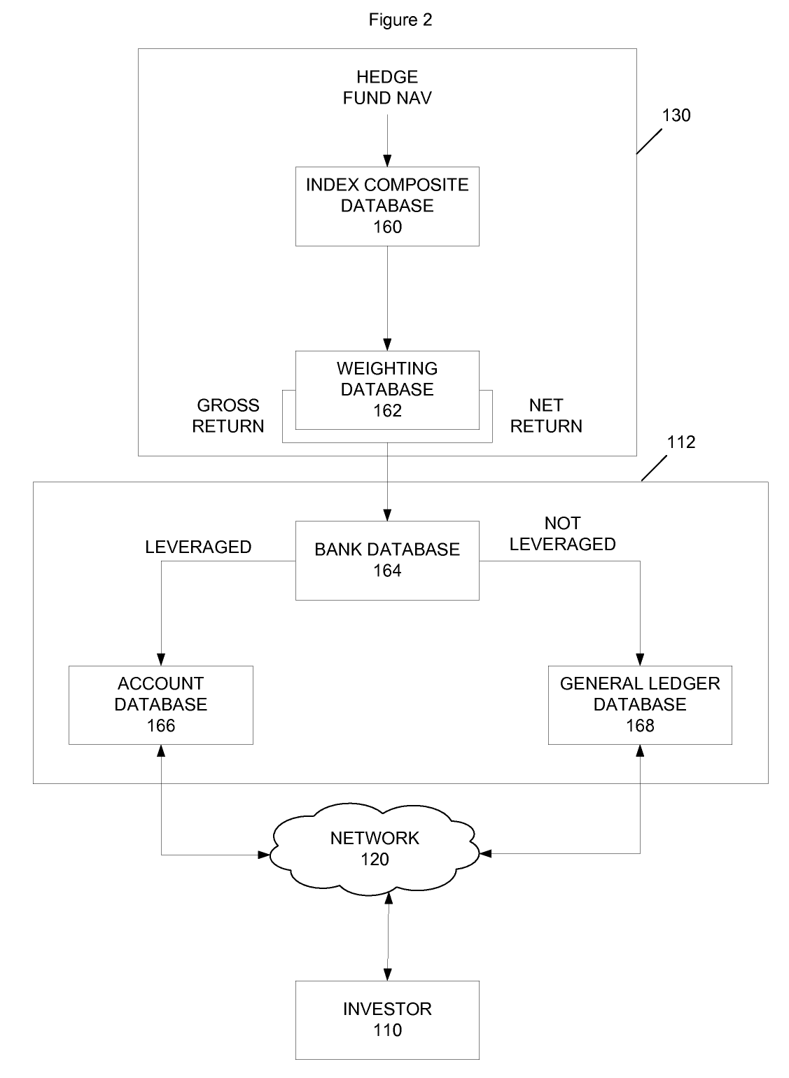

For example, referring to FIG. 2, the monthly hedge fund NAV for each hedge fund in the hedge fund index is stored in an index composite database 160. The composite values are, in turn, periodically communicated to a weighting database 162. The weighting database 162 is configured to weight the investments in each of the hedge funds according to a predetermined scheme. This data is, in turn, communicated to a database 164 at the bank 112.

At the bank 112, leveraged investments in the hedge fund index 130 are stored in an account database 166, and non-leveraged investments are stored in a general ledger database 168. The investor 110 can, in turn, obtain information about the investor's account by accessing the databases 166, 168 through the network 120. Other configurations are possible.

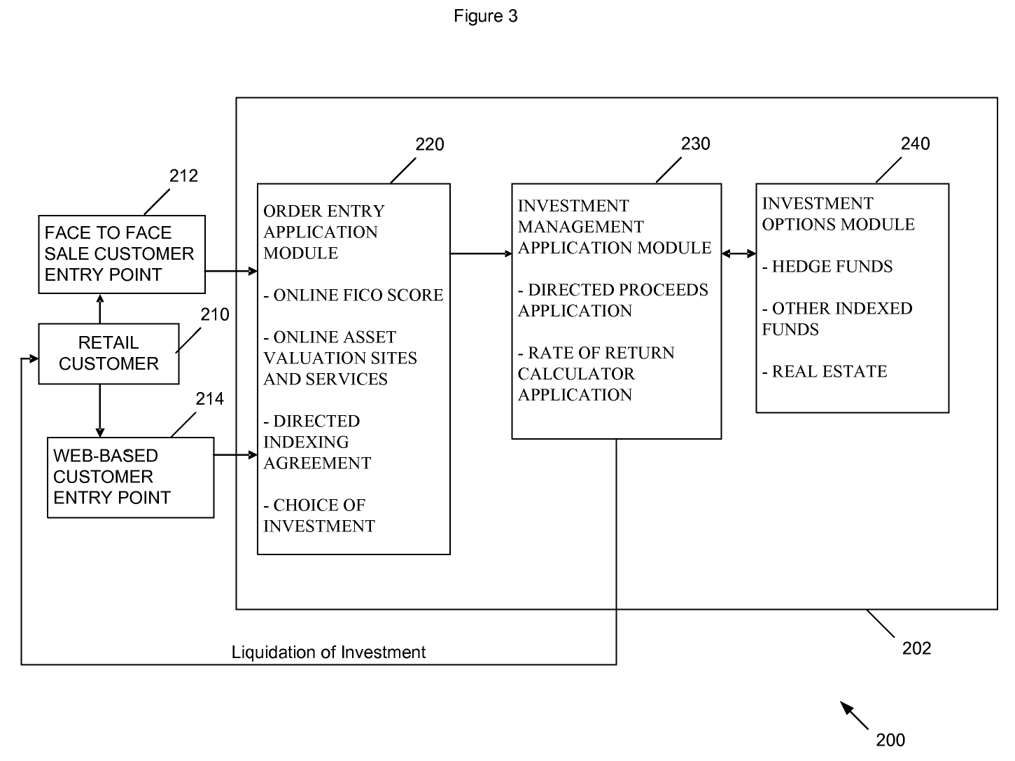

Referring now to FIG. 3, a second embodiment of a system 200 is shown. Similar to that shown in FIG. 1, the system 200 allows an investor, such as a retail customer 210, to invest in one or more investment vehicles offered by a hedge fund index system 202.

The retail customer 210 accesses the hedge fund index system 202 through a face-to-face customer entry point 212 or a web-based customer entry point 214. The face-to-face customer entry point 212 can be a traditional brick and mortar store with sales people, or a telephonic entry system with operators (automated or human).

The web-based customer entry point 214 can be a website hosted on a server that is accessible through a network such as the Internet. For example, the retail customer 210 can access the hedge fund index system 202 by using a computer system that includes a web browser that connects through the Internet to a web site hosted on a server of the hedge fund index system 202.

In example embodiments, the computer system is a laptop computer, a desktop computer, a Personal Data Assistant (PDA), a smartphone mobile telephone, or a similar computing device. The computer includes a processing unit and computer readable media. Computer readable media can include memory such as volatile (such as RAM), non-volatile (such as ROM, flash memory, etc.) or some combination thereof. Additionally, computer readable media can include mass storage (removable and/or non-removable) such as a magnetic or optical disks or tape. An operating system, such as Linux or Windows, one or more application programs, and other information such as databases can be stored on the mass storage device. The computer includes input devices (such as a keyboard and mouse) and output devices (such as a monitor and printer). The user computer also includes network connections to other devices, computers, networks, servers, etc., that are connected to a network.

In the embodiments disclosed herein, the customer 210 accesses the system 202 through the computer using the web browser that interprets known languages, such as hypertext markup language (“HTML”) and/or extensible markup language (“XML”). One example of a browser is the Internet Explorer browser offered by Microsoft Corporation. Other types of browsers and configurations are possible.

Once connected, the retail customer 210 is presented with an example order entry application 220 that allows the customer 210 to provide the information needed to sign up for investment in the hedge fund index.

For example, the order entry application 220 includes a bibliographic information collection module that collects information about the customer 210 so that the credit history for the customer 210 can be pulled from one or more of the credit bureaus and a FICO credit score can be calculated. The FICO score can be used by the system 202 to determine whether or not to allow the customer 210 to invest in the hedge fund index, as well as to set the particular terms provided to the customer 210.

The order entry application 220 also includes an online asset valuation sites and services module that provides information that assists the customer 210 in valuating assets that can be used for investment in the hedge fund index provided by the system 202. For example, the online asset valuation sites and services module can provide information to allow the customer 210 to value real estate should the customer 210 be interested in using the real estate to secure capital for investment in the hedge fund index, as described below. The online asset valuation sites and services module can provide other valuation information as well, such as tools that help the customer 210 to value securities portfolios.

The order entry application 220 includes a directed indexing agreement module that presents the customer 210 with the terms of the agreement for investment in the hedge fund index. For example, the directed indexing agreement module can be programmed to present the customer 210 with a legal instrument that, when executed electronically or physically, establishes the directed indexing account on the system 202.

The order entry application 220 also includes a choice of investment module that allows the customer 210 to select among one or more investment choices that are used to fund the purchase of shares in the hedge fund index. For example, in the embodiment shown, the customer 210 chooses between a secured real estate loan, a secured securities portfolio loan, an unsecured signature loan, and an investment secured by a certificate of deposit loan. In other examples, other types of investment choices can also be provided, such as: loans on insurance policies; college fund savings accounts; health savings accounts; retirement accounts such as 401K's; and future value gift cards or accounts. Other investment choices can also be provided.

In example embodiments, the terms of the transaction can vary depending on the type of investment selected by the customer 210. For example, the customer 210 can be provided with more favorable terms (e.g., a higher rate of return) if the customer 210 selects a secured investment rather than an unsecured investment. In other examples, more favorable terms are offered to customers with higher credit scores.

In the example shown, in addition to the order entry module 220, the customer 210 is also presented with an investment management application module 230 and an investment options module 240.

The investment management application module 230 allows the customer 210 to select a directed proceeds application that allows the customer 210 to liquidate the assets that are held in the hedge fund index. This liquidation can be accomplished by wiring the proceeds to a bank account, or by sending a check to the customer 210. The proceeds can also be used by the customer 210 to reinvest in another hedge fund index or other investment option offered by the system 202, as described below.

The investment management application module 230 also allows the customer 210 to select a rate of return calculator application that allows the customer 210 to estimate the amount of return on the investment. In one example, the rate of return calculator can calculate such information as annual percentage rate, net asset value, etc.

The investment management application module 230 also allows the customer to track current investment performance in the hedge fund index. For example, the investment management application module 230 is programmed to provide the user with an interface displaying terms and performance for the investment, as shown in example Table 1 below.

TABLE 1

| | Investor | | | | NAV | Trn | Current | Current | | % | % Return |
|---|---|---|---|---|---|---|---|---|---|---|---|
| Sr | Name | Date | Amount | NAV | Date | Days | NAV | Value | Total | CAGR | (Abs.) |
| No | Eurekahedge Eastern Europe &Russia Hedge Fund Index | | | | | | | | | | |
| 1 | George | Feb. 27, 2004 | 1000 | 10.13 | 15-Mar | 718 | 16.678 | 1,647 | 1,647 | 28.87 | 64.7 |
| | Winston | | | | | | | | | | |
| 2 | George | Apr. 03, 2004 | 1000 | 11.16 | 15-Mar | 683 | 16.678 | 1,494 | 1,494 | 23.93 | 49.4 |
| | Winston | | | | | | | | | | |
| 3 | George | May 02, 2004 | 1000 | 11.49 | 15-Mar | 654 | 16.678 | 1,451 | 1,451 | 23.09 | 45.1 |
| | Winston | | | | | | | | | | |
| 4 | George | Jun. 01, 2004 | 1000 | 9.621 | 15-Mar | 624 | 16.678 | 1,733 | 1,733 | 37.94 | 73.3 |
| | Winston | | | | | | | | | | |
| 5 | George | Jul. 03, 2004 | 1000 | 9.544 | 15-Mar | 592 | 16.678 | 1,747 | 1,747 | 41.05 | 74.7 |
| | Winston | | | | | | | | | | |
| 6 | George | Aug. 01, 2004 | 1000 | 9.664 | 15-Mar | 563 | 16.678 | 1,726 | 1,726 | 42.45 | 72.6 |
| | Winston | | | | | | | | | | |
| 7 | George | Sep. 01, 2004 | 1000 | 10.69 | 15-Mar | 532 | 16.678 | 1,560 | 1,560 | 35.68 | 56 |
| | Winston | | | | | | | | | | |
| 8 | George | Oct. 03, 2004 | 1000 | 11.2 | 15-Mar | 500 | 16.678 | 1,489 | 1,489 | 33.72 | 48.9 |
| | Winston | | | | | | | | | | |
| 9 | George | Nov. 01, 2004 | 1000 | 11.72 | 15-Mar | 471 | 16.678 | 1,423 | 1,423 | 31.44 | 42.3 |
| | Winston | | | | | | | | | | |
| 10 | George | Dec. 01, 2004 | 1000 | 12.47 | 15-Mar | 441 | 16.678 | 1,338 | 1,338 | 27.25 | 33.8 |
| | Winston | | | | | | | | | | |
| 11 | George | Jan. 02, 2005 | 1000 | 12.63 | 15-Mar | 409 | 16.678 | 1,321 | 1,321 | 28.2 | 32.1 |
| | Winston | | | | | | | | | | |
| 12 | George | Feb. 01, 2005 | 1000 | 13.08 | 15-Mar | 379 | 16.678 | 1,275 | 1,275 | 26.36 | 27.5 |
| | Winston | | | | | | | | | | |
| 13 | George | Mar. 01, 2005 | 1000 | 12.29 | 15-Mar | 351 | 16.678 | 1,357 | 1,357 | 37.12 | 35.7 |
| | Winston | | | | | | | | | | |

| | | | |
|---|---|---|---|
| Sub Total | 13,000 | 19,561 | 19,561 |

The investment options module 240 allows the customer 210 to select one or more investment vehicles, such as hedge funds, other indexed funds, and real estate. For example, although the embodiments described herein refer to investment in a hedge fund index, in alternative embodiments, the system 202 can facilitate investment in other options as well.

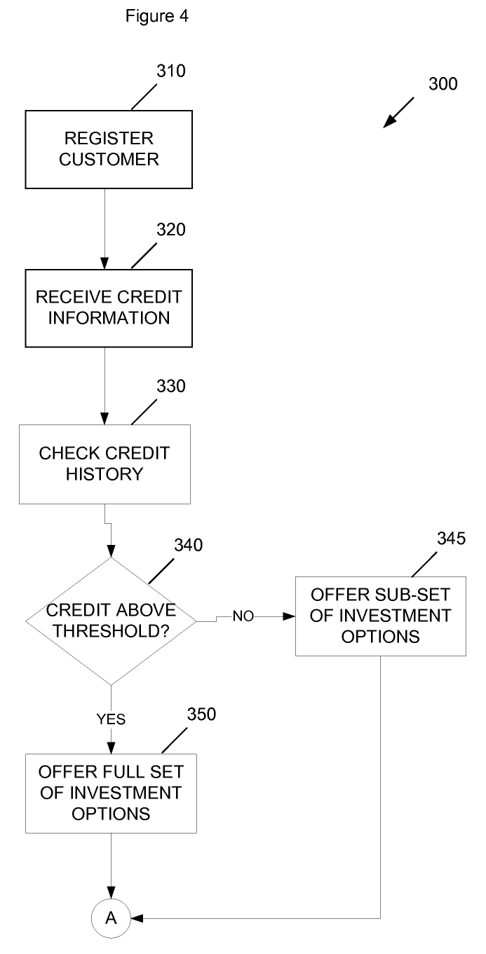

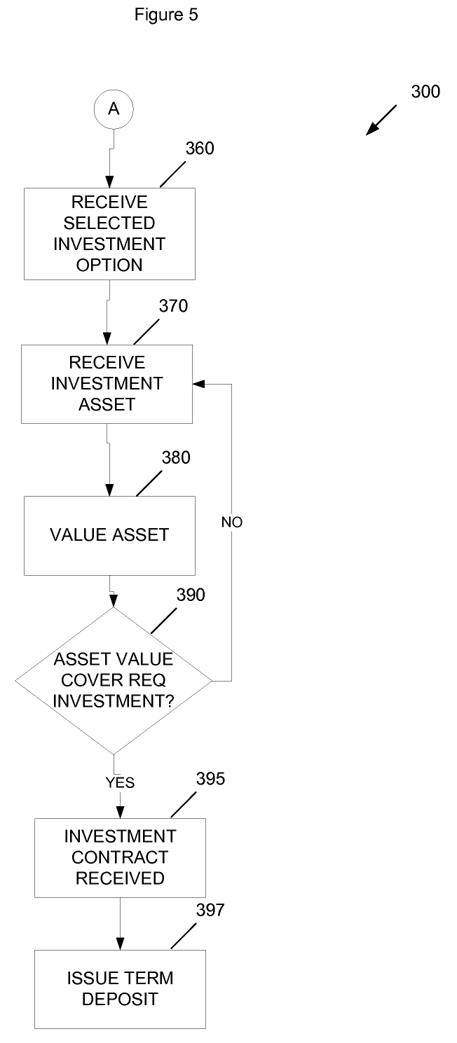

Referring now to FIGS. 4 and 5, an example method 300 for an investor to invest in a hedge fund index is shown. Initially, at operation 310, the customer registers with the system. The customer can provide information such as name, address, email address, and other bibliographical information. The customer can be provided with a user name and password, and a customer account is created.

Next, at operation 320, the customer's credit information is received. This information can include, for example, information that is necessary to conduct a credit check, such as full name and social security number. At operation 330, a credit check is performed using a third party credit provider. Control is then passed to operation 340, and the credit score for the credit check is examined. For example, depending on the customer's credit score, various investment options can be presented to the customer. If the credit score is below a certain threshold, control is passed to operation 345, and the customer is offered a sub-set of investment options. For example, the customer may be offered only investment options that require secured collateral. In other examples, the customer may not be allowed to invest in the hedge fund index if the customer's credit score falls below a certain threshold. Other configurations are possible.

Alternatively, if the customer's credit score is above the threshold, control is passed to operation 350 and the customer is offered a full set of investment options. In example embodiments, the investment options can include a selection between different hedge fund indexes that offer different terms for return. Other investment options, such as other indexed funds and real estate, can also be provided.

Next, at operation 360, the customer's selection of investment is received. Control is the passed to operation 370, and the assets associated with the investment are received from the customer. Next, at operation 380, the asset value is assessed. For example, if the customer's asset is a real estate loan, the value of the real estate is assessed by, for example, accessing one or more property databases to assess the current value of the property and any currently mortgages thereon. In some embodiments, the asset valuation can be semi-automated or fully automated so that the system can automatically assess the value of the asset.

Next, at operation 390, a determination is made as to whether or not the asset is sufficient to cover the requested investment. If not, control is passed back to operation 370 for further asset pledging by the customer. For example, the valuation of the asset is presented to the customer, and the customer is allowed to pledge further assets. These further assets are also valued.

Alternatively, if the pledged assets are sufficient, control is passed to operation 395. At operation 395, the executed investment contract is received from the customer. In the examples shown, the contract is presented and executed electronically. Finally, at operation 397, the term deposit is issued from the financial institution to the customer.

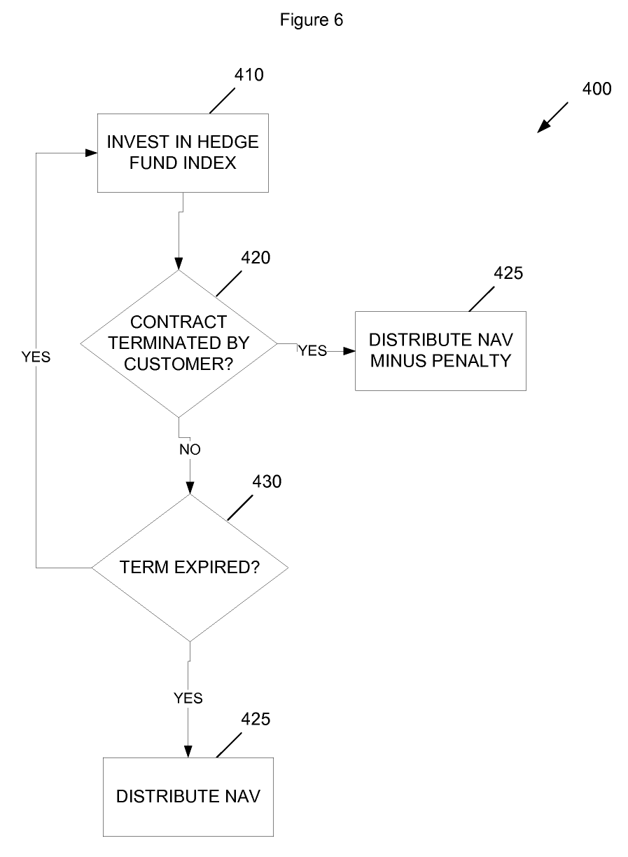

Referring now to FIG. 6, an example method 400 for the financial institution to manage the customer's investment is shown. Initially, at operation 410, the financial institution invests the funds associated with the customer's assets in the hedge fund index on the customer's behalf.

Next, at operation 420, a determination is made as to whether or not the customer has terminated the contract prematurely. If so, control is passed to operation 425. At operation 425, the NAV is calculated and distributed to the customer, minus any pre-payment penalties as defined in the contract. As described above, the NAV can include the principal invested, as well as a profit sharing component based on the performance of the hedge fund index. If not, control is instead passed to operation 430.

At operation 430, a determination is made as to whether or not the term has expired on the customer's deposit. If not, control is passed back to operation 410, and the funds remain invested in the hedge fund index. If the term has expired, control is instead passed to operation 425. At operation 425, the NAV is distributed to the customer. For example, the funds can be electronically deposited in the customer's checking or savings account at the financial institution. Alternatively, the customer can request that the funds be automatically re-invested upon maturity of the deposit.

Various modifications and alterations of this disclosure will become apparent to those skilled in the art without departing from the scope and spirit of this disclosure, and it should be understood that the inventive scope of this disclosure is not to be unduly limited to the illustrative embodiments set forth herein.

What is claimed is:

1. An online investment system, comprising:
an entry module programmed to receive information about an investor, retrieve the investor's credit score, and value one or more assets pledged by the investor to fund the investor's investment; and
an investment options module programmed to offer the investor a plurality of investment options based on the investor's credit score, at least one of the investment options including a term deposit tied to performance of a hedge fund index.

2. The system of claim 1, further comprising an investment management application module programmed to allow the investor to liquidate assets that are held in the term deposit.

3. The system of claim 2, wherein the investment management application module is further programmed to allow the investor to track current performance of the hedge fund index.

4. The system of claim 3, wherein the investment management application module is programmed to provide the investor with an interface displaying terms and performance for the investor's investment option.

5. The system of claim 1, wherein the entry module is further programmed to present the investor with a directed indexing agreement defining terms of the investor's selected investment option.

6. The system of claim 1, wherein the entry module further includes a choice investments module programmed to present the investor with a plurality of investment choices for the investor to fund the investor's investment, the investment choices including one or more of: a secured real estate loan; a secured securities portfolio loan; an unsecured signature loan; an investment secured by a certificate of deposit loan; loans on insurance policies; college fund savings accounts; health savings accounts; retirement accounts; and future value gift cards or accounts.

7. The system of claim 1, wherein the term deposit is an exempt variable rate term certificate of deposit.

8. A method for investing in an online hedge fund index, the method comprising:
receiving information about the investor;
performing a credit check on the investor;
offering a plurality of investment options to the investor based in part on results of the credit check, at least one of the investment options including a term deposit tied to performance of a hedge fund index;
receiving assets to fund the investor's choice of investment;
estimating a value of the assets; and
receiving an executed agreement from the investor for the investor's selected investment option.

9. The method of claim 8, further comprising allowing the investor to liquidate assets that are held in the term deposit.

10. The method of claim 8, further comprising allowing the investor to track current performance of the hedge fund index.

11. The method of claim 8, further comprising displaying terms and performance for the investor's investment option.

12. The method of claim 8, further comprising presenting the investor with a directed indexing agreement defining terms of the investor's selected investment option.

13. The method of claim 8, further comprising presenting the investor with a plurality of investment choices for the investor to fund the investor's investment, the investment choices including one or more of: a secured real estate loan; a secured securities portfolio loan; an unsecured signature loan; an investment secured by a certificate of deposit loan; loans on insurance policies; college fund savings accounts; health savings accounts; retirement accounts; and future value gift cards or accounts.

14. The method of claim 8, wherein the term deposit is an exempt variable rate term certificate of deposit.

15. A method for a financial institution to offer a non-accredited investor access to a hedge fund index, the method comprising:
receiving information about the investor;
performing a credit check on the investor;
offering a certificate of deposit based in part on results of the credit check, performance of the certificate of deposit being tied to performance of a hedge fund index;
presenting the investor with a plurality of investment choices for the investor to fund the investor's investment, the investment choices including one or more of: a secured real estate loan; a secured securities portfolio loan; an unsecured signature loan; an investment secured by a certificate of deposit loan; loans on insurance policies; college fund savings accounts; health savings accounts; retirement accounts; and future value gift cards or accounts;
valuating assets provided by the investor based on the investment choices;
receiving an executed agreement from the investor for the certificate of deposit;
investing the assets from the investor in the hedge fund index; and
paying proceeds of the certificate of deposit at maturity, at least a portion of the proceedings being tied to the performance of the hedge fund index.

16. The method of claim 15, wherein the certificate of deposit is an exempt variable rate term certificate of deposit.
